(19) United States
(12) Patent Application Publication
(10) Pub. No.: US 2016/0084993 A1
(43) Pub. Date: Mar. 24, 2016

(54) METHOD FOR PREPARING POLARIZING PLATE INCLUDING OPERATION OF ADJUSTING POLARIZER COLOR BY UV IRRADIATION

(71) Applicant: LG CHEM, LTD., Seoul (KR)

(72) Inventors: Jong-Hyun JUNG, Daejeon (KR); Sung-Hyun NAM, Daejeon (KR); Kyun-Il RAH, Daejeon (KR)

(21) Appl. No.: 14/385,737

(22) PCT Filed: Jun. 12, 2014
(86) PCT No.: PCT/KR2014/005183

§ 371 Date: Sep. 16, 2014

(30) Foreign Application Priority Data
Jun. 12, 2013 (KR) 10-2013-0067396
Jun. 10, 2014 (KR) 10-2014-0070108

(51) Int. Cl. G02B 1/12; B32B 37/12; G02B 5/30

(52) U.S. Cl. CPC G02B 1/12; G02B 5/3025; B32B 37/12; B32B 2329/04; B32B 2551/00

(57) ABSTRACT

There is provided a method for preparing a polarizer including preparing a polyvinyl alcohol-based film exhausted with iodine or dichroic dye and then elongated, and adjusting the color of a polarizer by irradiating polarized ultraviolet light onto the elongated polyvinyl alcohol-based film.

### TECHNICAL FIELD

The present disclosure relates to a method for preparing a polarizer and a polarizing plate, and in particular, to a method for preparing a polarizing plate capable of being used in image display devices such as a liquid crystal display devices, organic light emitting display devices and a plasma display panels (PDPs).

### BACKGROUND ART

Generally, in liquid crystal display devices, polarizers are disposed on both sides of liquid crystal surface panels in order to provide an image that is bright and has favorable color reproducibility. A polarizer is generally prepared by exhausting a polyvinyl alcohol-based film with a dichroic material such as iodine, then cross-linking the result using a cross-linking agent, and orienting the result using a method such as monoaxial elongation. The polarizer readily shrinks since it is prepared through elongation, and particularly, the polyvinyl alcohol-based film is readily deformed under humidifying thermal conditions since hydrophilic polymers are used. In addition, problems such as tearing of the film may occur since mechanical strength of the film itself is relatively weak. Accordingly, a polarizing plate of which strength is supplemented by adhering a protective film on both sides or one side of a polarizer has been used.

Meanwhile, the application of liquid crystal display devices has been expanded, and liquid crystal display devices are widely used in devices from mobile phones to home big-screen televisions, and technological development has progressed, so as to assure superior display qualities in respective liquid crystal display devices. The color of a polarizer is as important as a degree of polarization in the display quality of a liquid crystal display device.

In the related art, in order to adjust the color of a polarizer, methods such as adjusting an exhaustion amount of I₅⁻, adjusting a period for which a polyvinyl alcohol-based film is immersed in a treatment bath, or adjusting a temperature, and the like, has been used in an exhaustion operation.

However, I₅⁻ is relatively difficult to produce, unless the level of orientation of a polyvinyl alcohol-based film is higher than a certain level, and even if I₅⁻is produced, the amount thereof may be relatively small, therefore, adjusting the color of a polarizer by adjusting the amount of I₅⁻ exhaustion in the polarizer has been difficult.

In addition, a period of immersion in a cross-linking bath may be adjusted in a cross-linking operation for color adjustments; however, in such a method, the period of immersion in a cross-linking bath needs to be adjusted when elongation conditions are changed in the elongation operation, therefore, color adjustments are relatively difficult.

As described above, existing methods of adjusting polarizer color have had problems in that the control is difficult, and a separate treatment is required for color adjustments since color changes along with changes in the conditions of exhaustion, cross-linking and elongation operations.

### DISCLOSURE

### Technical Problem

An aspect of the present disclosure has been made in view of the above, and an object of the present disclosure is to provide a method for preparing a polarizer which is simpler than existing methods for preparing a polarizer, and adjusting the color of a polarizer without discoloration due to a temperature increase of the polarizer.

### Technical Solution

According to an aspect of the present disclosure, there is provided a method for preparing a polarizer including preparing a polyvinyl alcohol-based film exhausted with iodine or dichroic dye and then elongated, and adjusting the color of a polarizer by irradiating polarized ultraviolet light onto the elongated polyvinyl alcohol-based film.

The operation of adjusting the color of a polarizer may be carried out so that the value of the following Equation 1 ranges from 0.05 to 0.2.

$$\frac{\begin{matrix}single body color after irradiating ultraviolet light - \\ Single body color b before irradiating ultraviolet light\end{matrix}}{ \begin{matrix}Single body color b value \\ before irradiating ultraviolet light\end{matrix} } \qquad [ Equation 1 ]$$

In addition, the operation of adjusting the color of a polarizer may be carried out so that the value of the following Equation 2 ranges from 0.4 to 1.2.

$$\frac{\begin{matrix}\begin{matrix}Orthogonal color b value after \\ irradiating ultraviolet light\end{matrix} - \\ Orthogonal color b before irradiating ultraviolet light\end{matrix}}{ \begin{matrix}Single body b value \\ before irradiating ultraviolet light\end{matrix} } \qquad [ Equation 2 ]$$

Furthermore, the operation of adjusting the color of a polarizer may be carried out so that the value of the following Equation 3 ranges from 0.004 to 0.028.

$$\frac{\begin{matrix}\begin{matrix}Single body transmittance after irradiating \\ ultraviolet light\end{matrix} - \\ Single body transmittance before irradiating \\ ultraviolet light\end{matrix}}{ \begin{matrix}Single body transmittance \\ before irradiating ultraviolet light\end{matrix}} \qquad [ Equation 3 ]$$

Meanwhile, the polarized ultraviolet light may be formed using a wire grid polarizer.

Herein, the polarization direction of the polarized ultraviolet light may preferably form an angle ranging from 0 to 1.0 degrees with respect to an absorption axis of the polyvinyl alcohol-based film, and may be more preferably provided in parallel with respect to an absorption axis of the polyvinyl alcohol-based film.

In addition, the polarized ultraviolet light may have intensity ranging from 0.5 to 3 J/cm².

Furthermore, after going through the operation of adjusting the color of a polarizer by the polarized ultraviolet light irradiation, a temperature of the polarizer may range from 20° C. to 70° C.

Meanwhile, the method for preparing a polarizer may further include a cooling operation for lowering a temperature of the polarizer.

Herein, the cooling operation may use a cooling roll having a temperature ranging from 10° C. to 30° C.

Meanwhile, according to another aspect of the present disclosure, there is provided a method for preparing a polarizing plate including preparing a polyvinyl alcohol-based film exhausted with iodine or dichroic dye and then elongated, adjusting the color of a polarizer by irradiating polarized ultraviolet light on the elongated polyvinyl alcohol-based film, and adhering a protective film on at least one side surface of the polarizer.

### Advantageous Effects

A method for preparing a polarizer of the present disclosure has an advantage in that the method is capable of adjusting the color changes of a polarizer independently from an exhaustion operation, a cross-linking operation and an elongation operation of the polarizer by adjusting the color of the polarizer after the elongation operation using ultraviolet light irradiation.

Herein, the degree of the polarizer color changes according to the intensity of ultraviolet light can be predicted, therefore, there are superior effects in that the color of the polarizer may be readily and accurately adjusted, and only the color of the polarizer is changed without affecting a degree of polarization.

In addition, by using polarized ultraviolet light in the ultraviolet light irradiation, a temperature increase of the polarizer due to the ultraviolet light irradiation may be suppressed, therefore, discoloration due to the temperature increase of the polarizer may be prevented, and predictable color adjustments can be achieved.

### BRIEF DESCRIPTION OF DRAWING

FIG. 1 shows an example of irradiating polarized ultraviolet light onto a polyvinyl alcohol-based film.

FIG. 2 is a graph illustrating changes in single body transmittance and an absorbance value according to intensity of polarized ultraviolet light.

FIG. 3 is a graph illustrating changes in a single body color b value according to intensity of polarized ultraviolet light.

FIG. 4 is a picture illustrating the surface of a polarizer prepared according to Example 1.

FIG. 5 is a picture illustrating the surface of a polarizer prepared according to Comparative Example 2.

### BEST MODE

Exemplary embodiments of the present disclosure will now be described. The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

The inventors of the present disclosure have repeatedly carried out research into a method for preparing a polarizer, to develop a method that allows for adjustments in the color of a polarizer regardless of an elongation operation, found that such an objective may be accomplished by including an operation of irradiating polarized ultraviolet light after an elongation operation, and completed the present disclosure.

A method for preparing a polarizer according to the exemplary embodiment of the present disclosure includes an operation of preparing a polyvinyl alcohol-based film exhausted with iodine or dichroic dye and then elongated, and adjusting the color of a polarizer by irradiating polarized ultraviolet light onto the elongated polyvinyl alcohol-based film.

Hereinafter, each operation of the preparation method according to the exemplary embodiment of the present disclosure will be described in more detail.

First, a polyvinyl alcohol-based film exhausted with iodine or dichroic dye and then elongated is prepared. Herein, the operation of preparing a polyvinyl alcohol-based film exhausted with iodine or dichroic dye and then elongated may prepare the film through methods for preparing a polyvinyl alcohol-based polarizer well-known in the related art, or use commercially available films.

Meanwhile, the method for preparing a polyvinyl alcohol-based polarizer may be carried out through an exhaustion operation of exhausting a polyvinyl alcohol-based film with iodine or dichroic dye, a cross-linking operation of cross-linking the polyvinyl alcohol-based film and the iodine or dichroic dye, and an elongation operation of elongating the polyvinyl alcohol-based film.

First, the exhaustion operation is for exhausting iodine molecules or dichroic dye molecules having dichroism on a polyvinyl alcohol-based film, and the iodine molecules or dichroic dye molecules allow the operation to obtain polarized light having specific vibration direction by absorbing light that vibrates in the elongation direction of the polarizing plate and passing light that vibrates in the vertical direction of the polarizing plate through. Herein, exhaustion is generally achieved by immersing the polyvinyl alcohol-based film in a treatment bath filled with a solution containing iodine or dichroic dye.

Herein, water is generally used as a solvent used in the solution of the exhaustion operation, however, organic solvents having compatibility with water may be added in moderate amounts. Meanwhile, the iodine or dichroic dye may be used in a ratio ranging from 0.06 parts by weight to 0.25 parts by weight with respect to 100 parts by weight of the solvent. When the iodine or dichroic dye is within the above range, single body transmittance of the polarizer prepared after elongation satisfies a range of 42.0% to 47.0%.

Meanwhile, when iodine is used as the dichroic material, an aid such as an iodide may be additionally included in order to improve exhaustion efficiency, and the aid may be used in a ratio ranging from 0.3 parts by weight to 2.5 parts by weight with respect to 100 parts by weight of the solvent. Herein, the aid such as an iodide is added in order to increase the solubility of iodine for water since iodine has low solubility in water. Meanwhile, a mixing ratio of the iodine and the iodide may range from approximately 1:5 to 1:10.

Herein, specific examples of the iodide that may be included in the exemplary embodiment of the present disclosure include potassium iodide, lithium iodide, sodium iodide, zinc iodide, aluminum iodide, lead iodide, copper iodide, barium iodide, calcium iodide, tin iodide, titanium iodide, a mixture thereof, or the like; however, the present embodiment is not limited thereto.

Meanwhile, a temperature of the treatment bath may be maintained at approximately 25° C. to 40° C., due to the fact that exhaustion efficiency may decrease at a low temperature of less than 25° C., and the amount of iodine used may increase due to the increased sublimation of iodine at a high temperature of greater than 40° C. In addition, the period of polyvinyl alcohol-based film immersion in the treatment bath may be for approximately 30 seconds to 120 seconds, due to the fact that that uniform exhaustion on the polyvinyl alcohol-based film may not be achieved when the immersion period is less than for 30 seconds, and immersion is no longer required since exhaustion is saturated when the period is greater than for 120 seconds.

Meanwhile, an immersion method carried out by immersing the polyvinyl alcohol-based film in an aqueous boric acid solution and the like is generally used in the cross-linking operation; however, a coating method or a spraying method, in which a solution is sprayed on a film, may also be used.

Herein, as one example of the cross-linking operation, when iodine molecules or dichroic dye molecules exhaust a polyvinyl alcohol-based film using an exhaustion operation, the immersion method is carried out by having the iodine molecules or dichroic dye molecules being adsorbed on the polymer matrix of the polyvinyl alcohol-based film using a cross-linking agent, and immersing the polyvinyl alcohol-based film in a cross-linking bath filled with a solution containing the cross-linking agent. This is due to the fact that when the iodine molecules or dichroic dye molecules are not properly adsorbed on the polymer matrix, the degree of polarization decreases and as a result, a polarizing plate may not play its role properly.

Herein, water is generally used as a solvent used in the solution of the cross-linking bath, however, organic solvents having compatibility with water may be added in moderate amounts, and the cross-linking agent may be added in a ratio ranging from 0.5 parts by weight to 5.0 parts by weight with respect to 100 parts by weight of the solvent. Herein, when the cross-linking agent is included in less than 0.5 parts by weight, the strength of the polyvinyl alcohol-based film may decrease in water due to the lack of cross-linking in the polyvinyl alcohol-based film, and when included in an amount greater than 5.0 parts by weight, the elongation properties of the polyvinyl alcohol-based film are degraded due to excess cross-link formation.

In addition, specific examples of the cross-linking agent include boron compounds such as boric acid and borax, glyoxal, glutaraldehyde and the like, and these may be used either alone or as a combination thereof.

Meanwhile, the temperature of the cross-linking bath is different depending on the amount of the cross-linking agent and the elongation percentage, and while not being limited thereto, may have a range of 45° C. to 60° C. Generally, as the amount of a cross-linking agent increases, the temperature of a cross-linking bath is adjusted to a high temperature in order to improve the mobility of a polyvinyl alcohol-based film chain, and when the amount of a cross-linking agent is small, the temperature of a cross-linking bath is adjusted to a relatively low temperature. However, in the exemplary embodiment of the present disclosure, the temperature of the cross-linking bath needs to be maintained at 45° C. or higher for improving the elongation property of the polyvinyl alcohol-based film since elongation of 5 times or greater is obtained.

Meanwhile, the period of the polyvinyl alcohol-based film immersion in the cross-linking bath may be for approximately 30 seconds to 120 seconds, due to the fact that that uniform exhaustion on the polyvinyl alcohol-based film may not be achieved when the immersion time is less than for 30 seconds, and immersion is no longer required since exhaustion is saturated when the period is greater than 120 seconds

Meanwhile, elongation in the elongation operation refers to monoaxially stretching a film in order to elongate the polymers of the film in certain directions. The elongation method may be divided into a wet elongation method and a dry elongation method, and the dry elongation method may again be divided into an inter-roll elongation method, a heating roll elongation method, a compression elongation method, a tenter elongation method and the like, and the wet elongation method may again be divided into a tenter elongation method, an inter-roll elongation method, and the like.

The elongation method in the exemplary embodiment of the present disclosure is not particularly limited, and both the wet elongation method and the dry elongation method may be used, and a combination thereof may also be used when necessary.

Herein, the elongation operation may elongate the polyvinyl alcohol-based film to an elongation of 4 times to 7 times, and at an elongation temperature of 45° C. to 60° C. In order to provide polarizability to a polyvinyl alcohol-based film, the chain of a polyvinyl alcohol-based film needs to be elongated, and the chain orientation may not sufficiently occur at an elongation of less than 4 times, and the chain of a polyvinyl alcohol-based film may be cut at an elongation of greater than 7 times. In addition, the elongation temperature may be different depending on the content of a cross-linking agent. Elongation efficiency may be reduced at a temperature of less than 45° C. since the mobility of a polyvinyl alcohol-based film chain is reduced, and when the temperature is greater than 60° C., the strength of a polyvinyl alcohol-based film may be weakened due to the softening of the film.

Meanwhile, the elongation operation may be carried out either simultaneously or separately with the exhaustion operation or the cross-linking operation. When the elongation operation is carried out simultaneously with the exhaustion operation, the exhaustion operation may be carried out in an iodine solution, and when simultaneously carried out with the cross-linking operation, the exhaustion operation may be carried out in an aqueous boric acid solution.

Meanwhile, the operation of preparing an elongated polyvinyl alcohol-based film in the exemplary embodiment of the present disclosure may further include an operation of drying a laminated body after the elongation operation. Herein, the drying, while not being limited thereto, may be carried out at a temperature preferably ranging from approximately 20° C. to 100° C., and more preferably ranging from approximately 40° C. to 90° C. considering the optical properties of a polarizer, and the drying period is preferably for 1 to 10 minutes. The drying process functions to prevent the property degradation of a polyvinyl alcohol-based polarizer due to moisture in a polarizer preparation process through the removal of the moisture on the surface of and inside the polyvinyl alcohol, and to improve the degree of polarization of a polarizer by smoothly inducing the shrinkage of the elongated polyvinyl alcohol-based film width in the drying process thereby improving the orientation of a complex formed with polyvinyl alcohol and iodine. Herein, the drying operation may be carried out after carrying out exhaustion, cross-linking, complementary color treatment and the like.

When the elongated polyvinyl alcohol-based film is prepared through the method described above, the operation of adjusting the color of a polarizer by irradiating polarized ultraviolet light onto the prepared polyvinyl alcohol-based film is carried out.

According to the results of research undertaken by the inventors of the present disclosure, it can be seen that, when the operation of ultraviolet light irradiation is carried out on the elongated polarizer, a color b value and single body transmittance of a polarizer may be adjusted as desired depending on the intensity of the ultraviolet light. More specifically, when ultraviolet light is irradiated onto a polyvinyl alcohol-based film exhausted with iodine or dichroic dye and then elongated, the iodine or dichroic dye molecules become energetically unstable due to vibration motions or excited to an electron excited state, and in this process, the color of the polarizer may change or polarization is fully settled. Herein, when irradiating ultraviolet light with a suitable amount of energy, the color of the polarizer may be adjusted to any desired color. However, when irradiating non-polarized ultraviolet light onto a polarizer as described above, temperatures in some areas of the polarizer increase, and this is identified as causing discoloration or stains in the polarizer.

The inventors of the present disclosure have repeatedly carried out research in order to prevent such discoloration or stains in a polarizer, and found that such problems may be solved by irradiating polarized ultraviolet light as the ultraviolet light. Specifically, when polarized ultraviolet light is used, the temperature increase of the polarizer is suppressed in an irradiation operation, and the occurrence of unpredictable discoloration and stains of the polarizer are prevented, since the amount of energy absorbed by the polarizer per unit area is small. Accordingly, the method for preparing a polarizer of the exemplary embodiment of the present disclosure is a very simple process and allows for the preparation of a polarizer having target colors regardless of process conditions in exhaustion, cross-linking and elongation operations, therefore, complicate color adjustment recipes are not required, which is different to existing methods.

Meanwhile, the polarized ultraviolet light is ultraviolet light polarized using methods well-known in the related art, and while not being limited thereto, may use a wire grid polarizer in terms of efficiency and process convenience.

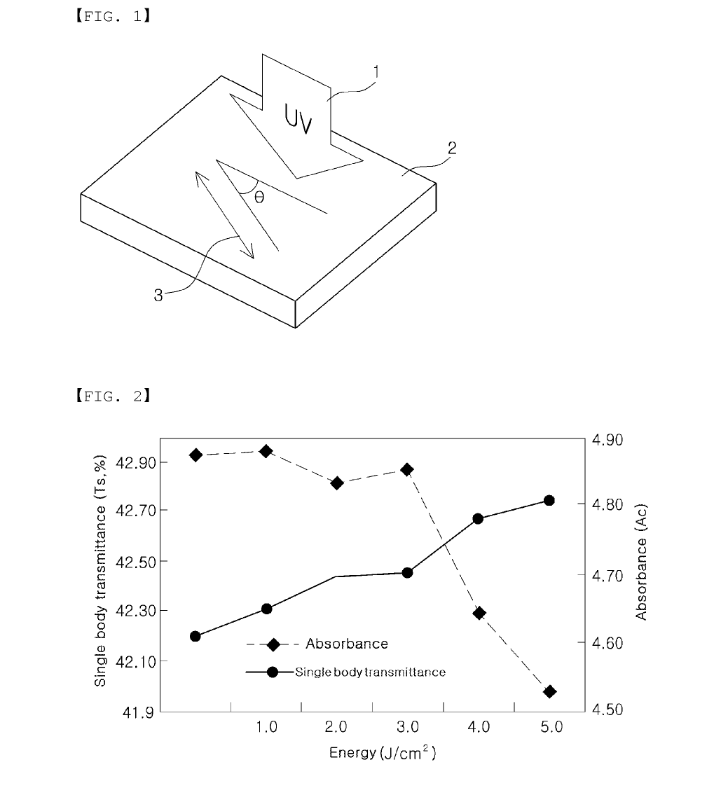

Specifically, the method for preparing a polarizer in the exemplary embodiment of the present disclosure may be carried out by irradiating polarized ultraviolet light onto the surface of a polyvinyl alcohol-based film using an ultraviolet light lamp and an ultraviolet light polarizer (a wire grid polarizer). Herein, as illustrated by a diagram in FIG. 1, by adjusting the polarization direction of irradiated ultraviolet light (for example, rotation of a ultraviolet light polarizer, and the like), the ultraviolet light may be adjusted to be irradiated at an arbitrary angle (θ) with respect to an absorption axis of the polarizer.

Herein, the polarization direction of the polarized ultraviolet light may form an angle ranging from 0 to 1.0 degrees with respect to the absorption axis of the polarizer. In particular, irradiating so that the polarization direction of the polarized ultraviolet light is parallel (θ=0°) with respect to the absorption axis of the film is most preferable. Satisfying the above range is advantageous in terms of irradiation efficiency of the irradiated polarized ultraviolet light and heat generation.

Meanwhile, the operation of adjusting the color of a polarizer, while not being limited thereto, may be carried out so that the value of the following Equation 1 ranges from 0.05 to 0.2, and for example, carrying out so that the value of the following Equation 1 ranges from 0.1 to 0.2 is preferable. When the change ratio of single body color b values before and after irradiating polarized ultraviolet light is within the above range, only the single body color b value may be adjusted without affecting the degree of polarization of the polarizer.

$$\frac{\begin{matrix}single body color after irradiating ultraviolet light - \\ Single body color b before irradiating ultraviolet light\end{matrix}}{ \begin{matrix}Single body color b value \\ before irradiating ultraviolet light\end{matrix} } \qquad [ Equation 1 ]$$

Here, single body color in the single body color b value represents measuring a single polarizer color using a color-difference meter, a color b value refers to a value expressing the color in a CIE coordinate system, and the color b value is calculated by b=200[(Y/Yn)^{1/3}−(Z/Zn)^{1/3}] with +b referring to yellow and −b referring to blue.

(Herein, Yn and Zn correspond to Y and Z of benchmark white.) In other words, the single body color b value refers to a color b value in a CIE coordinate system measuring a single polarizer color using a color-difference meter.

In the exemplary embodiment of the present disclosure, the single body color b value is measured using a V-7000 UV-VIS-NIR Spectrophotometer (a piece of optical measuring equipment) by JASCO, and the single body color b value is measured by the optical measuring equipment and displayed as a value. Herein, the single body color b value being high or low in a polarizer refers to absorbance in a short wavelength being high or low, and more specifically, when absorbance in a short wavelength is high, the single body color b value is high, and when absorbance in a short wavelength is low, the single body color b value is low.

Meanwhile, in the exemplary embodiment of the present disclosure, the single body color b value of the polarizer after irradiating ultraviolet light may satisfy a range of 3.5 to 4.0. When a polarizing plate is orthogonally disposed, a bluish color tone is evident when the single body color b value is less than 3.5, and a yellowish color tone is evident when the single body color b value is greater than 4.0, therefore, natural black is hard to obtain, and the CR value may decrease. When the single body color b value of an elongated polarizer does not satisfy the above range, the single body color b value may be changed by irradiating polarized ultraviolet light, and herein, the single body color b value may be adjusted to be within the above range by adjusting the intensity of the polarized ultraviolet light.

In addition, the operation of adjusting the color of a polarizer, while not being limited thereto, may be carried out so that the value of the following Equation 2 ranges from 0.4 to 1.2, and for example, the case in which the value of the following Equation 2 ranges from 0.5 to 1.0 is preferable. When the change ratio of orthogonal color b values before and after irradiating polarized ultraviolet light is within the above range, only the orthogonal color b value may be adjusted without affecting the degree of polarization of a polarizer.

$$\frac{\begin{matrix}\begin{matrix}Orthogonal color b value after \\ irradiating ultraviolet light\end{matrix} - \\ Orthogonal color b before irradiating ultraviolet light\end{matrix}}{ \begin{matrix}Single body b value \\ before irradiating ultraviolet light\end{matrix} } \qquad [ Equation 2 ]$$

Herein, orthogonal color in the orthogonal color b value represents measuring the color of a pair of polarizers when absorption axes thereof are disposed to be orthogonal with respect to each other using a color-difference meter, and a color b value refers to a value expressing the color in a CIE coordinate system, and the color b value is calculated by b=200[(Y/Yn)^{1/3}−(Z/Zn)^{1/3}] with +b referring to yellow and −b referring to blue. (Herein, Yn and Zn correspond to Y and Z of benchmark white.) In other words, the orthogonal color b value refers to a color b value in a CIE coordinate system measuring the color of a pair of polarizers when absorption axes thereof are disposed to be orthogonal.

Meanwhile, the orthogonal color b value is measured using a V-7000 UV-VIS-NIR Spectrophotometer (a piece of optical measuring equipment) by JASCO. Herein, while not being limited thereto, the orthogonal color b value of the polarizer after irradiating ultraviolet light in the exemplary embodiment of the present disclosure may range from approximately −1 to 1, a value closer to 0 being preferable, since natural black may be obtained.

As an example of adjusting the orthogonal color b value of the present disclosure, the orthogonal color b value may be increased and adjusted close to 0 when the orthogonal color b value appears to be less than 0 after exhaustion, cross-linking and elongation operations.

Meanwhile, according to the results of research carried out by the inventors of the present disclosure, it is illustrated that single body transmittance of a polarizer may be adjusted as well as the color of a polarizer when irradiating polarized ultraviolet light onto the polarizer. In other words, when a polarizer does not have target single body transmittance after exhaustion, cross-linking and elongation operations, the single body transmittance may be changed just by irradiating polarized ultraviolet light. In addition, according to the exemplary embodiment of the present disclosure, the changes in the single body transmittance according to the intensity of polarized ultraviolet light may be predicted, therefore, there is an advantage in that the single body transmittance may be simply adjusted within a target value range by irradiating polarized ultraviolet light with the intensity just as much as needed to change.

For example, the operation of adjusting the color of a polarizer may be carried out so that the value of the following Equation 3 ranges from 0.004 to 0.028, and for example, carrying out so that the value of the following Equation 3 ranges from 0.01 to 0.028 is preferable. When single body transmittance before and after irradiating polarized ultraviolet light is within the above range, only the single body transmittance may be adjusted without affecting the degree of polarization of a polarizer.

$$\frac{\begin{matrix}\begin{matrix}Single body transmittance after irradiating \\ ultraviolet light\end{matrix} - \\ Single body transmittance before irradiating \\ ultraviolet light\end{matrix}}{ \begin{matrix}Single body transmittance \\ before irradiating ultraviolet light\end{matrix}} \qquad [ Equation 3 ]$$

Herein, the single body transmittance refers to transmittance of a single polarizer, and the single body transmittance is measured using a V-7000 UV-VIS-NIR Spectrophotometer (a piece of optical measuring equipment) by JASCO in the exemplary embodiment of the present disclosure.

The single body transmittance of the polarizer prepared using the method according to the exemplary embodiment of the present disclosure may satisfy a value range of 42.0% to 47%, and for example, the value may range from 42.5% to 43%. When the transmittance of the polarizer is less than 42%, the screen may be dark since due to the high absorption of light, and when the transmittance is greater than 47%, the degree of polarization decreases and black may not be properly obtained.

Meanwhile, the polarized ultraviolet light may be irradiated more preferably with intensity ranging from 0.5 to 3.0 J/cm², and for example, may be irradiated with intensity of 0.8 J/cm² to 1.5 J/cm². When the polarized ultraviolet light intensity satisfies the above range, sufficient color changes occur, and curing of a polarizer due to ultraviolet light may be prevented, therefore, color adjustments may be readily achieved. In addition to this, as described above, ultraviolet light irradiation may energetically destabilize iodine or dichroic dye molecules thereby solve polarization, and consequently, color adjustments may be achieved without decreasing the degree of polarization when the intensity of the ultraviolet light intensity satisfies the above range.

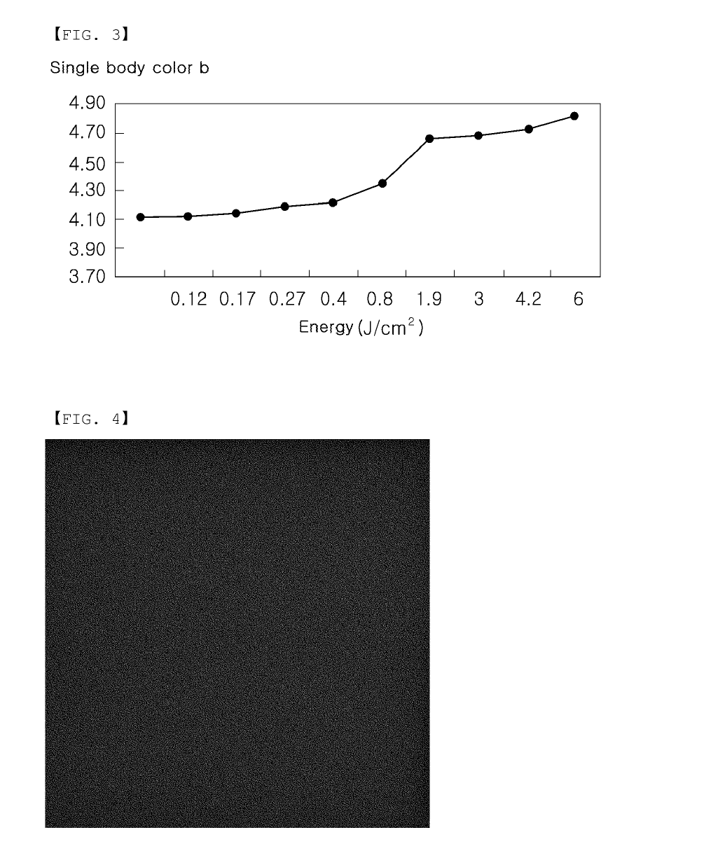

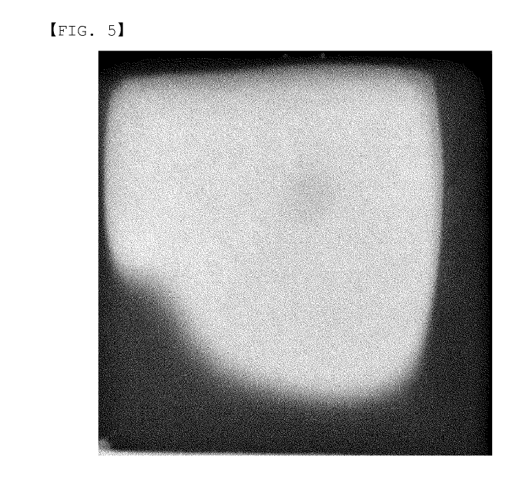

FIG. 2 is a graph illustrating changes in an absorbance value by an orthogonal transmittance value according to the intensity of ultraviolet light. Herein, the x axis of FIG. 2 represents intensity (J/cm²) of ultraviolet light, and the y axis represents an absorbance value (Ac) by an orthogonal transmittance value (Tc), and when the orthogonal transmittance is Tc, the absorbance value Ac is calculated as −log(Tc). Meanwhile, having a large absorbance value (Ac) refers to having a small orthogonal transmittance value (Tc), and having a small orthogonal transmittance value (Tc) refers to having a large degree of polarization due to favorable iodine orientation.

As illustrated in the graph of FIG. 2, when the intensity of polarized ultraviolet light is greater than 3 J/cm², the absorbance value (Ac) rapidly decreases. When the absorbance value (Ac) decreases as described above, the orthogonal transmittance (Tc) value increases, and the degree of polarization decreases. In other words, the phenomenon of orthogonal transmittance (Tc) value being increased occurs due to an adverse effect on the orientation of a polyvinyl alcohol-based film as the intensity of polarized ultraviolet light exceeds 3 J/cm².

In addition, the following FIG. 3 is a graph illustrating changes in a single body color b value according to the intensity of polarized ultraviolet light. Herein, the x axis of FIG. 3 represents intensity (J/cm²) of polarized ultraviolet light, and the b value of the y axis refers to a single body color b value. Through FIG. 3, it can be seen that, when the intensity of polarized ultraviolet light is low energy of less than 0.5 J/cm², the color changes in a polarizer is insignificant, and polarized ultraviolet light having minimal intensity of 0.5 J/cm² is required in order to adjust the color of a polarizer.

Meanwhile, after going through the operation of adjusting the color of a polarizer by irradiating polarized ultraviolet light, the temperature of the polarizer preferably ranges from approximately 20° C. to 70° C., and more preferably ranges from approximately 25° C. to 60° C. As above, when ultraviolet light is irradiated, the elongation film exhausted with iodine or dichroic dye experiences a temperature increase, and in the case of a polyvinyl alcohol-based film, when the temperature of the film surface passes above 80° C., I₅⁻, which absorbs visible light in a long wavelength range, is decomposed, and consequently, there is a problem in that the film is discolored and eventually has stains across the polarizer and undergoes shape deformation. However, when irradiating the polarized ultraviolet light according to the exemplary embodiment of the present disclosure, the temperature of a polarizer after irradiating the ultraviolet light satisfies the above range, and in this case, the occurrence of discoloration and stains of a polarizer significantly decreases.

Meanwhile, the method for preparing a polarizer according to the exemplary embodiment of the present disclosure may further include a cooling operation for lowering the temperature of a polarizer. As seen above, a problem of stains and discoloration may occur due to the temperature increase of a polarizer when ultraviolet light is irradiated onto the polarizer, and the cooling operation is an additional process in order to prevent this phenomenon. Herein, the cooling operation may be carried out before or after the operation of adjusting the color of a polarizer, however, carrying out after polarized ultraviolet light irradiation is preferable in terms that the cooling operation suppresses the temperature increase of a polarizer due to ultraviolet light irradiation.

More specifically, the cooling operation may be carried out simultaneously in the operation of irradiating ultraviolet light or an operation of winding, or as a separate process before/after the operation of irradiating ultraviolet light. The cooling operation may, while not being limited thereto, for example, use a cooling roll, and may be carried out using the roll used in the elongation operation or the winding operation carried out before/after the operation of irradiating ultraviolet light as a low temperature cooling roll. Particularly, the cooling operation is most preferably carried out between the operation of drying an elongated polarizer and the operation of winding, considering the operation of irradiating polarized ultraviolet light.

Meanwhile, the cooling operation preferably has a temperature ranging from approximately 10° C. to 60° C., and more preferably uses a cooling roll having a temperature of approximately 10° C. to 30° C. or 10° C. to 20° C. is. When the temperature of a cooling roll satisfies the above range, the temperature of a film itself may be lowered without film damages and deformation.

Meanwhile, a polarizer prepared using the preparation method according to the exemplary embodiment of the present disclosure as described above has little difference in the degree of polarization between before and after ultraviolet light irradiation. In existing color adjusting methods, there has been a problem in that separate color adjustments are difficult to achieve since the degree of polarization changes while adjusting the color of a polarizer, however, the method for preparing a polarizer according to the exemplary embodiment of the present disclosure has superior effects in that the method is capable of changing only the color of a polarizer without affecting the degree of polarization. In other words, a polarizer prepared using the method for preparing a polarizer according to exemplary embodiment of the present disclosure has an advantage in that a polarizer having an excellent degree of polarization while simply and elaborately adjusting the color property of the polarizer may be prepared by irradiating polarized ultraviolet light.

Furthermore, in existing methods, a degree of polarization (DOP) generally decreases when single body transmittance (Ts) increases. Accordingly, there has been a problem in that a degree of polarization decreases when increasing single body transmittance by changing the conditions of exhaustion, cross-linking and elongation operations of a polarizer in existing methods, however, when single body transmittance of a polarizer is adjusted by irradiating polarized ultraviolet light after exhaustion, cross-linking and elongation operations as in the exemplary embodiment of the present disclosure, there is an advantage in that a degree of polarization may be maintained at a certain level while increasing single body transmittance.

In addition, a polarizer prepared using the preparation method according to the exemplary embodiment of the present disclosure may have a degree of polarization of 99.995% or greater, and for example, having a degree of polarization of 99.996% or greater, or 99.997% or greater, is more preferable. When a degree of polarization is high, a polarizing plate having an excellent contrast ratio (CR) may be prepared, and when the color of a polarizer is adjusted by irradiating polarized ultraviolet light according to the preparation method of the exemplary embodiment of the disclosure, there is an advantage in that a polarizer having an excellent degree of polarization of 99.995% or greater may be prepared.

Meanwhile, a degree of polarization is defined by A/{(Ts−Tc)/(Ts+Tc)}, and herein, Is refers to single body transmittance, and Tc refers to orthogonal transmittance. In addition, the orthogonal transmittance refers to transmittance when a pair of polarizers are disposed so that their absorption axes are orthogonal.

Next, according to another aspect of the present disclosure, there is provided a method for preparing a polarizing plate including preparing a polyvinyl alcohol-based film exhausted with iodine or dichroic dye and then elongated, adjusting the color of a polarizer by irradiating polarized ultraviolet light onto the elongated polyvinyl alcohol-based film, and adhering a protective film on at least one side surface of the polarizer.

The operation of preparing a polyvinyl alcohol-based film exhausted with iodine or dichroic dye and then elongated, and the operation of adjusting the color of a polarizer by irradiating polarized ultraviolet light onto the elongated polyvinyl alcohol-based film are the same as those described above, therefore, specific descriptions will not be repeated.

When a polarizer of which color is adjusted through the method described above is prepared, a polarizing plate is prepared by carrying out the operation of adhering a protective film on at least one side surface of the polarizer. Herein, the operation of adhering a protective film may be carried out through preparation methods of a polarizing plate well-known in the related art, and the method is not particularly limited. For example, a method of coating an adhesive on one side or both sides of a polarizer, then adhering a protective film, and dry treating the result may be used. As the coating method, methods known in the related art such as a kneading method, a mayer bar method, an air knife method, a gravure printing method, a spraying method, a blade method, a die coater method, a casting method, a spin coating method, a reverse roll method, and a kiss roll method may be used; however, the method is not limited thereto. The drying treatment may be carried out using, for example, hot air, and at a drying temperature of approximately 40° C. to 100° C., and preferably at 60° C. to 100° C. for 20 seconds to 1,200 seconds.

Herein, the protective film may include various transparent films attaching to both sides of a polarizer for protecting the polarizer, and examples thereof may include an acetate-based resin film such as triacethyl cellulose (TAC), a polyester-based resin film, a polyethersulfone-based resin film, a polycarbonate-based resin film, a polyamide-based resin film, a polyimide-based resin film, a polyolefin-based resin film, an acrylic-based resin film and the like may be used; however, the protective film is not limited thereto.

Meanwhile, as the adhesive, an aqueous adhesive or a light curing-type adhesive may be used. The adhesive is not particularly limited in terms of type thereof, as long as it sufficiently adheres a polarizer to a protective film, has excellent optical transparency, and experiences no changes such as yellowing over time, however, for example, an aqueous adhesive composition containing a polyvinyl alcohol-based resin and a cross-linking agent may be used. In addition, the polarizing plate may additionally include functional films such as a wide viewing angle compensation film or a luminance improving film in addition to the protective film in order for additional performance improvements.

### MODE FOR INVENTION

Hereinafter, preferred exemplary embodiments of the present disclosure will be described in order to aid in understanding the present disclosure. However, it should be understood that the description set forth herein is merely exemplary and illustrative of exemplary embodiments for the purpose of describing the present disclosure, and is not intended to limit the present disclosure.

### Preparation Example

A polarizer was prepared by passing a polyvinyl alcohol (PVA)-based film (manufactured by Nippon Synthetic Chemical Industry Co. Ltd., degree of polymerization: 2600) through a rinsing tank and a swelling tank, exhausting the result in an aqueous solution including I₂ and KI, and then elongating up to 6 times in an aqueous solution containing boric acid and KI.

### Example 1

After measuring single body transmittance, a single body color b value and an orthogonal color b value of the polyvinyl alcohol-based polarizer prepared according to the preparation example, polarized ultraviolet light (Fusion UV systems, Inc., UV 16B) of which a polarization direction is parallel with respect to the absorption axis was irradiated onto the prepared polarizer with an energy of 0.5 J/cm², and then single body transmittance, a single body color b value and an orthogonal color b value were measured.

### Example 2

After measuring single body transmittance, a single body color b value and an orthogonal color b value of the polyvinyl alcohol-based polarizer prepared according to the preparation example, polarized ultraviolet light (Fusion UV systems, Inc., UV 16B) of which a polarization direction is parallel with respect to the absorption axis was irradiated onto the prepared polarizer with an energy of 1.0 J/cm², and then single body transmittance, a single body color b value and an orthogonal color b value were measured.

### Example 3

After measuring single body transmittance, a single body color b value and an orthogonal color b value of the polyvinyl alcohol-based polarizer prepared according to the preparation example, polarized ultraviolet light (Fusion UV systems, Inc., UV 16B) of which a polarization direction is parallel with respect to the absorption axis was irradiated onto the prepared polarizer with an energy of 1.5 J/cm², and then single body transmittance, a single body color b value and an orthogonal color b value were measured.

### Example 4

After measuring single body transmittance, a single body color b value and an orthogonal color b value of the polyvinyl alcohol-based polarizer prepared according to the preparation example, polarized ultraviolet light (Fusion UV systems, Inc., UV 16B) of which a polarization direction is parallel with respect to the absorption axis was irradiated onto the prepared polarizer with an energy of 2.0 J/cm², and then single body transmittance, a single body color b value and an orthogonal color b value were measured.

### Example 5

After measuring single body transmittance, a single body color b value and an orthogonal color b value of the polyvinyl alcohol-based polarizer prepared according to the preparation example, polarized ultraviolet light (Fusion UV systems, Inc., UV 16B) of which polarization direction is parallel with respect to the absorption axis was irradiated onto the prepared polarizer with an energy of 2.5 J/cm², and then single body transmittance, a single body color b value and an orthogonal color b value were measured.

### Comparative Example 1

After measuring single body transmittance, a single body color b value and an orthogonal color b value of the polyvinyl alcohol-based polarizer prepared according to the preparation example, non-polarized ultraviolet light (Fusion UV systems, Inc., UV 16B) of which polarization direction is parallel with respect to the absorption axis was irradiated onto the prepared polarizer with an energy of 2.5 J/cm², and then single body transmittance, a single body color b value and an orthogonal color b value were measured.

### Comparative Example 2

After measuring single body transmittance, a single body color b value and an orthogonal color b value of the polyvinyl alcohol-based polarizer prepared according to the preparation example, polarized ultraviolet light (Fusion UV systems, Inc., UV 16B) of which polarization direction is parallel with respect to the absorption axis was irradiated onto the prepared polarizer with an energy of 5.0 J/cm², and then single body transmittance, a single body color b value and an orthogonal color b value were measured.

Each value measured before irradiating ultraviolet light and each value measured after irradiating ultraviolet light of specific intensity in Examples 1 to 5 and Comparatives Examples 1 to 2 was converted to a changed amount using the following Equation 4, and the changed amounts and the polarizer temperatures after irradiating ultraviolet light are illustrated in the following Table 1.

$$Changed amount = \frac{\begin{matrix}Value measured after irradiating \\ ultraviolet light \\ Value measured before irradiating \\ ultraviolet light\end{matrix} -}{ \begin{matrix}Value measured before \\ irradiating ultraviolet light\end{matrix}} \qquad [ Equation 4 ]$$

TABLE 1

| | | Changed | | | |
|---|---|---|---|---|---|
| | | Amount | | | Polarizer |
| | | in | Changed | Changed | Temperature |
| | Ultraviolet | Single | Amount in | Amount in | after |
| | Light | Body | Orthogonal | Single Body | Irradiating |
| | Intensity | color b | Color b | Transmittance\ | Ultraviolet |
| Category | (J/cm²) | value | Value | (%) | Light (° C.) |
| Example 1 | 0.5 | 0.056 | 0.4 | 0.004 | 25 |
| Example 2 | 1.0 | 0.096 | 0.59 | 0.01 | 25 |
| Example 3 | 1.5 | 0.136 | 0.85 | 0.016 | 30 |
| Example 4 | 2.0 | 0.164 | 1 | 0.02 | 40 |
| Example 5 | 2.5 | 0.192 | 1.17 | 0.028 | 55 |
| Comparative | 2.5 (non- | 0.272 | 3.25 | 0.36 | 85 |
| Example 1 | polarized) | | | | |
| Comparative | 5.0 | 1.230 | 5.33 | 0.54 | 105 |
| Example 2 | (polarized) | | | | |

Based on the results of Table 1, it can be seen that the single body transmittance, the single body color b value and the orthogonal color b value increase when irradiating ultraviolet light, and as the intensity of ultraviolet light increases, the amount of changes in each value increases. In addition, the exemplary embodiment of the present disclosure may predict the amount of changes in each value according to the intensity of ultraviolet light, therefore, each color value, transmittance and the like may be adjusted just by irradiating ultraviolet light of specific intensity after exhaustion, cross-linking and elongation operations. Furthermore, there is an advantage in that the color adjustments of a polarizer such as above may be carried out regardless of the condition changes in exhaustion, cross-linking and elongation operations.

In addition, when Example 5 and Comparative Example 1 are compared, the surface temperature of the polarizer exceeds 80° C. when irradiating non-polarized ultraviolet light with the same energy, resulting in the discoloration of the polarizer. Furthermore, when the irradiated energy exceeds 3 J/cm² as in Comparative Example 2, the surface temperature of the polarizer exceeds 100° C., and as a result, the color of the polarizer turns yellow, as verified in FIG. 5.

While examples of the present disclosure have been described in detail above, the scope of the present disclosure is not limited thereto, and it will be apparent to those skilled in the art that various modifications and variations could be made without departing from the spirit of the present disclosure as defined by the appended claims.

### REFERENCE NUMERALS

1: Polarized Ultraviolet Light
2: Polyvinyl Alcohol-Based Film
3: Absorption Axis of Polyvinyl Alcohol-Based Film

1. A method for preparing a polarizer, comprising:
preparing a polyvinyl alcohol-based film exhausted with iodine or dichroic dye and then elongated; and
adjusting the color of a polarizer by irradiating polarized ultraviolet light onto the elongated polyvinyl alcohol-based film.

2. The method for preparing a polarizer of claim 1, wherein the operation of adjusting the color of a polarizer is carried out so that the value of the following Equation 1 ranges from 0.05 to 0.2.
$$\frac{\begin{matrix}\begin{matrix}single body color b value after irradiating \\ ultraviolet light\end{matrix} \\ \begin{matrix}Single body color b value \\ before irradiating ultraviolet light\end{matrix} \end{matrix} -}{\begin{matrix}Single body color b value \\ before irradiating ultraviolet light\end{matrix} } \qquad [ Equation 1 ]$$

3. The method for preparing a polarizer of claim 1, wherein the operation of adjusting the color of a polarizer is carried out so that the value of the following Equation 2 ranges from 0.4 to 1.2.
$$\frac{\begin{matrix}\begin{matrix}Orthogonal color b value after \\ irradiating ultraviolet light\end{matrix} - \\ Orthogonal color b value before \\ irradiating ultraviolet light\end{matrix}}{ \begin{matrix}Orthogonal color b value before \\ irradiating ultraviolet light\end{matrix}} \qquad [ Equation 2 ]$$

4. The method for preparing a polarizer of claim 1, wherein the operation of adjusting the color of a polarizer is carried out so that the value of the following Equation 3 ranges from 0.004 to 0.028.
$$\frac{\begin{matrix}\begin{matrix}Single body transmittance after irradiating \\ ultraviolet light\end{matrix} - \\ Single body transmittance before irradiating \\ ultraviolet light\end{matrix}}{ \begin{matrix}Single body transmittance \\ before irradiating ultraviolet light\end{matrix}} . \qquad [ Equation 3 ]$$

5. The method for preparing a polarizer of claim 1, wherein the polarized ultraviolet light is formed using a wire grid polarizer.

6. The method for preparing a polarizer of claim 1, wherein a polarization direction of the polarized ultraviolet light forms an angle ranging from 0 to 1.0 degrees with respect to an absorption axis of the polyvinyl alcohol-based film.

7. The method for preparing a polarizer of claim 1, wherein a polarization direction of the polarized ultraviolet light is parallel with respect to an absorption axis of the polyvinyl alcohol-based film.

8. The method for preparing a polarizer of claim 1, wherein the polarized ultraviolet light has intensity ranging from 0.5 to 3 J/cm².

9. The method for preparing a polarizer of claim 1, wherein a temperature of the polarizer ranges from 20° C. to 70° C. after going through the operation of adjusting the color of a polarizer by irradiating polarized ultraviolet light.

10. The method for preparing a polarizer of claim 1, further comprising cooling operation for lowering a temperature of the polarizer.

11. The method for preparing a polarizer of claim 10, wherein the cooling operation uses a cooling roll having a temperature ranging from 10° C. to 30° C.

12. A method for preparing a polarizing plate, comprising:
preparing a polyvinyl alcohol-based film exhausted with iodine or dichroic dye and then elongated;
adjusting the color of a polarizer by irradiating polarized ultraviolet light onto the elongated polyvinyl alcohol-based film; and
adhering a protective film on at least one side surface of the polarizer.

13. The method for preparing a polarizing plate of claim 12, wherein the polarized ultraviolet light has intensity ranging from 0.5 to 3 J/cm².
